(19) United States
(12) Patent Application Publication
(10) Pub. No.: US 2014/0344551 A1
(43) Pub. Date: Nov. 20, 2014

(54) DUAL-MODE INSTRUCTION FETCHING APPARATUS AND METHOD

(71) Applicant: Electronics and Telecommunications Research Institute, Daejeon (KR)

(72) Inventor: Young-Su KWON, Daejeon (KR)

(73) Assignee: Electronics and Telecommunications Research Institute, Daejeon (KR)

(21) Appl. No.: 14/257,067

(22) Filed: Apr. 21, 2014

(30) Foreign Application Priority Data
May 14, 2013 (KR) 10-2013-0054239

(51) Int. Cl. G06F 9/38

(52) U.S. Cl. CPC G06F 9/3806
USPC 712/207

(57) ABSTRACT

The dual-mode instruction fetching apparatus includes a mode register, a branch prediction unit, a Program Counter (PC) calculator, an Instruction Queue (IQ), and a fetch multiplexer. The mode register is set to one of normal mode and line mode. The PC calculator accesses a tag in which the address indices of instructions have been stored or a line in which the instructions have been grouped and then outputs an instruction, or accesses only the line and then outputs an instruction depending on the type of set mode. The IQ stores instructions selected by an instruction selector from among the instructions grouped in the line. The fetch multiplexer fetches the instructions stored in the IQ if the normal mode has been set, and fetches instructions read from the line of an instruction cache if the line mode has been set.

### CROSS REFERENCE TO RELATED APPLICATION

This application claims the benefit of Korean Patent Application No. 10-2013-0054239, filed on May 14, 2013, which is hereby incorporated by reference in its entirety into this application.

### BACKGROUND OF THE INVENTION

1. Technical Field

The present invention relates generally to a dual-mode instruction fetching apparatus and method and, more particularly, to a dual-mode instruction fetching apparatus and method that can be employed in a processor core.

2. Description of the Related Art

Processors are widely applied to almost all the fields of system semiconductors. The application of processors has extended to a variety of fields including: the field of high-performance media data processing for large amounts of multimedia data, such as the compression and decompression of video data, the compression and decompression of audio data, the manipulation of audio data, and the processing of sound effects; the field of minimum-performance microcontroller platforms, such as modems for wired and wireless communication, voice codec algorithms, platforms for the processing of network data, touch screens, controllers for household appliances, platforms for the control of motors; and the field of devices to which power cannot be stably supplied or external power cannot be supplied, such as wireless sensor networks, and ultra-small electronic devices.

A processor basically includes a core, a translation lookaside buffer (TLB), and a cache. A task that will be performed by a processor is defined as a combination of a plurality of instructions. That is, instructions are stored in memory. When the instructions are sequentially input to the processor, the processor performs a specific operation in each clock cycle.

Processor cores are hardware or semiconductor intellectual property (IP) that read instructions stored in a storage device, such as memory or a disk, perform specific operations on operands in accordance with operations encoded in the instructions, and store the results of the operations in the storage device, thereby executing an algorithm for a specific application. The TLB functions to translate virtual addresses into physical addresses in order to run an application based on an operating system. The cache functions to increase the speed of the processor by temporarily storing instructions, stored in external memory, in a chip.

A recent 1 GHz or higher high-performance processor core essentially includes a deep pipeline structure. Such a pipeline structure can maximize an operating frequency, and can increase throughput. In contrast, when a branch instruction (i.e., branch prediction) is generated, a branch address (i.e., a target address) for a branch is determined in the latter half of a pipeline. Accordingly, the pipeline is cleared because instructions, already read in a clock cycle when the branch actually occurs and present on the pipeline, should not be executed. After the pipeline has been cleared, instructions are read from the branch address of the branch instruction again. In this case, a performance overhead of 10 clock cycles or more is generated.

In order to minimize such performance overhead, a branch prediction unit is contained in most of high-performance processor cores. The branch prediction unit implements the part of cache memory from which instructions are fetched, that is, instruction fetch hardware. The branch prediction unit includes a Branch Target Buffer (BTB) and a Branch Predictor (BP).

The BTB stores the Program Counter (PC) of a branch target that can be branched at a current PC or that has already been continuously recorded while the processor core operates. The value of a PC at a point at which a branch will be actually generated is determined by a branch instruction. The value is determined after the branch instruction has reached an execution unit and a specific calculation has been performed. After the execution unit has executed the branch instruction, the execution unit stores the value of the PC at the point determined by the branch instruction in the BTB. The content of the BTB changes whenever a branch instruction is generated because a branch instruction is continuously generated while the processor core operates.

The BP predicts whether a branch is actually generated. When a specific instruction is fetched based on the value of a PC, whether the instruction will actually generate the branch is determined only when the instruction reaches the execution unit. However, since the arrival of the instruction at the execution unit is determined after about 8 to 10 clock cycles, instructions read from an instruction cache (i.e., cache memory) during a clock cycle may not be actually executed and consumed. Accordingly, if branch prediction is performed in advance, instructions and clock cycles that are unnecessarily consumed can be reduced.

After a branch instruction has been executed in the execution unit, the execution unit stores information about whether the branch instruction generates a branch in the BP. When the information about whether the branch instruction generates a branch is stored in the BP, information about whether a branch will occur that will be determined based on the value of a current PC and a previous branch-related history when the same instruction will be input later is recorded. An instruction fetch unit reads prediction data regarding information about whether a branch will occur, which was already stored in the BP, and predicts whether the branch will occur immediately after an instruction has been fetched and before the instruction reaches the execution unit.

The BTB and the BP that predict whether a branch will occur and that predict a branch PC consume some clock cycles. Furthermore, power is consumed because memory for the BTB and the BP is read in each clock cycle. Furthermore, the pipeline depth is increased, and thus the BTB and the BP are useful in a high-performance processor core but become factors in a reduction in power and performance in a structure that does not require branch prediction.

As related art, Korean Patent No. 0216684 entitled “Instruction Branching Method and Processor” discloses technology in which a pipeline processor generates a branch schedule instruction capable of improving the efficiency of an instruction branch operation when a program is compiled.

The invention disclosed in Korean Patent No. 0216684 provides an instruction branching method, the method being performed by a processor while a program is being executed, the method including executing a branch schedule instruction by scheduling the address of a branch point and the address of a branch target, designated by the branch schedule instruction, in memory, determining whether an address from which an instruction will be read has reached the address of the branch point, and replacing the address from which the instruction will be read with the address of the branch target if, as a result of the determination, it is determined that the address from which the instruction will be read has reached the address of the branch point.

While the invention of Korean Patent No. 0216684 describes only that the instruction of a branch target is read based on branch schedule information, the invention does not suggest a dual instruction fetch path.

### SUMMARY OF THE INVENTION

Accordingly, the present invention has been made keeping in mind the above problems occurring in the conventional art, and an object of the present invention is to provide a dual-mode instruction fetching apparatus and method, which are capable of controlling a pipeline depth when the processor core reads an instruction from memory according to the characteristics of an application by implementing a dual and variable instruction fetch structure in a processor core.

In accordance with an aspect of the present invention, there is provided a dual-mode instruction fetching apparatus, including a mode register configured to be set to one of normal mode and line mode; a branch prediction unit; a Program Counter (PC) calculator configured to access a tag in which the address indices of instructions have been stored and a line in which the instructions have been grouped and then output an instruction, or to access only the line and then output an instruction, based on the output of the branch prediction unit, depending on the type of mode set in the mode register; an Instruction Queue (IQ) configured to store instructions selected by an instruction selector from among the instructions grouped in the line; and a fetch multiplexer configured to fetch the instructions stored in the IQ if the normal mode has been set, and to fetch instructions read from the line of an instruction cache if the line mode has been set.

If the mode register has been set to the normal mode, the PC calculator may access the tag and line of the instruction cache and then output an instruction, based on the output of the branch prediction unit.

If the mode register has been set to the line mode, the PC calculator may directly access the line of the instruction cache, other than the branch prediction unit and the tag of the instruction cache, and then output an instruction.

If the normal mode has been set, the fetch multiplexer may fetch an instruction that belongs to the instructions stored in the IQ and that has been stored first.

If the line mode has been set, the fetch multiplexer may fetch a first one of the instructions read from the line of the instruction cache.

In the normal mode, a Branch Target Buffer (BTB) of the branch prediction unit and the tag of the instruction cache may be accessed in a first clock cycle, a Branch Predictor (BP) of the branch prediction unit and the line of the instruction cache may be accessed in a second clock cycle, the branch prediction unit may determine whether a branch will occur and also the instructions selected by the instruction selector may be stored in the IQ in a third clock cycle, and the instructions stored in the IQ may be output through the fetch multiplexer in a fourth clock cycle.

In the line mode, the line of the instruction cache may be accessed based on the output of the PC calculator in a first clock cycle, and the first one of the instructions read from the line of the instruction cache may be output through the fetch multiplexer in a second clock cycle.

If the number of application instructions executed by a processor core is small or an application includes low-frequent branch instructions, the line mode may be set.

The instruction selector may decode each of the instructions grouped in the line of the instruction cache and then select instructions from among instructions ranging from a first instruction to an instruction prior to a branch instruction; and the IQ may store the instructions selected by the instruction selector.

The apparatus may be contained in a processor core having a pipeline structure.

In accordance with an aspect of the present invention, there is provided a dual-mode instruction fetching method, including setting, by a processor core, one of normal mode and line mode; fetching instructions through a PC calculator, a branch prediction unit, and an IQ in the normal mode; and fetching instructions through the PC calculator and a line of an instruction cache in the line mode.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the construction of a dual-mode instruction fetching apparatus according to an embodiment of the present invention;

FIG. 2 is a diagram illustrating a pipeline progress structure in normal mode according to an embodiment of the present invention; and

FIG. 3 is a diagram illustrating a pipeline progress structure in line mode according to an embodiment of the present invention.

### DESCRIPTION OF THE PREFERRED EMBODIMENTS

A dual-mode instruction fetching apparatus and method according to embodiments of the present invention will be described below with reference to the accompanying drawings. Prior to the following detailed description of the present invention, it should be noted that the terms and words used in the specification and the claims should not be construed as being limited to ordinary meanings or dictionary definitions. Meanwhile, the embodiments described in the specification and the configurations illustrated in the drawings are merely examples and do not exhaustively present the technical spirit of the present invention. Accordingly, it should be appreciated that there may be various equivalents and modifications that can replace the embodiments and the configurations at the time at which the present application is filed.

The present invention proposes a structure for directly reading stored instructions without intervention of a BTB and a BP by fetching the instructions using an instruction cache in Static Random Access Memory (SRAM) form in addition to a high-performance pipeline structure for reading instructions through the BTB, the BP and the instruction cache. More particularly, the present invention proposes a dual-mode instruction fetch structure in a high-performance processor core. In normal mode, instructions are fetched through a four-step pipeline that is composed of a PC calculator, a BTB, a BP, and an Instruction Queue (IQ), and, in line mode, instructions are fetched through a two-step pipeline that is composed of the PC calculator and an instruction cache.

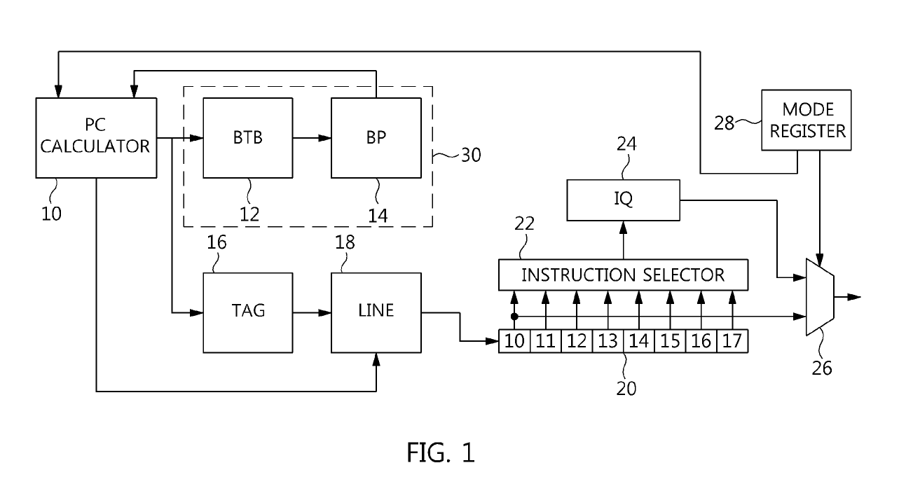

FIG. 1 is a diagram illustrating the construction of a dual-mode instruction fetching apparatus according to an embodiment of the present invention.

The dual-mode instruction fetching apparatus according to an embodiment of the present invention includes a PC calculator (also called a PC decision unit) 10, a BTB 12, a BP 14, the tag 16 of an instruction cache (not illustrated), the line 18 of the instruction cache, an instruction selector 22, an IQ 24, a fetch multiplexer 26, and a mode register 28.

The PC calculator 10 accesses the tag 16 in which the address indices of instructions stored in the instruction cache have been stored and the line 18 in which the instructions are grouped and then outputs an instruction, or accesses only the line 18 and then outputs an instruction, based on the output of a branch prediction unit (12 and 14). In other words, the PC calculator 10 calculates the memory address of an instruction read in a corresponding clock cycle. The memory address of the instruction is the address of the instruction cache (memory) at which the instruction is located. The PC calculator 10 outputs a sequentially increasing value from a PC in a previous clock cycle, or outputs a memory address at which a branch is predicted. Such a determination depends on the results of branch prediction performed by the BP 14. If the BP 14 determines that a branch does not occur, the PC calculator 10 outputs a sequentially increasing value from a PC in a previous clock cycle, and reads an instruction subsequent to an instruction in the previous clock cycle from the tag 16 and line 18 of the instruction cache. If the BP 14 determines that a branch occurs, the PC calculator 10 outputs a memory address predicted by the BP 14, and reads a corresponding instruction from the tag 16 and line 18 of the instruction cache.

In particular, the PC calculator 10 receives a value (i.e., a value indicative that normal or line mode has been set) set in the mode register 28. The value set in the mode register 28 may be represented as set information or a set signal. Accordingly, the PC calculator 10 uses the branch prediction unit (12 and 14) if it becomes aware that normal mode has been set, and does not use the branch prediction unit (12 and 14) if it becomes aware that line mode has been set. That is, if normal mode has been set, the PC calculator 10 activates the branch prediction unit (12 and 14), and outputs an instruction from the tag 16 and line 18 of the instruction cache using the output of the branch prediction unit (12 and 14). If line mode has been set, the PC calculator 10 deactivates the branch prediction unit (12 and 14), directly accesses the line 18 of the instruction cache without using the output of the branch prediction unit (12 and 14), and then outputs an instruction. For example, if a processor core processes graphics data, the processor core does not generate a branch instruction because it commonly performs a repetitive operation. In such a case, the processor core sets line mode through its own operation. If the number of application instructions executed by the processor core as described above is small or if an application includes low-frequent branch instructions, or both, line mode may be set. Accordingly, if line mode has been set, it is effective to improve overall performance because a pipeline depth can be reduced as compared with that in normal mode.

As a result, it may be considered that the PC calculator 10 accesses the tag 16 in which the address indices of instructions have been stored and the line 18 in which the instructions have been grouped and then outputs an instruction, or accesses only the line 18 and then outputs an instruction by, based on the output of the branch prediction unit (12 and 14), depending on the type of mode set in the mode register 28.

The BTB 12 may include memory and logic. The BTB 12 stores a PC at a point at which a branch is possible at a current PC or at which has been continuously recorded while the processor core operates. Accordingly, the PC calculator 10 may read a branch address at which a branch is possible at a current PC from the BTB 12 because the branch can be predicted from the current PC.

The BP 14 may include memory and logic. The BP 14 predicts whether a branch will occur in an instruction corresponding to a PC as a result of the calculation of the PC calculator 10. The result of the BP 14 is sent to the PC calculator 10, and determines the output result of the PC calculator 10.

The BTB 12 and the BP 14 may be collectively called the branch prediction unit 30 that predicts whether a branch will occur in an instruction corresponding to the value of a PC.

The result of the PC calculator 10 is used to read the tag 16 of the instruction cache. The tag 16 of the instruction cache stores the address indices of instructions currently stored in the instruction cache. That is, if, as a result of accessing the tag 16 of the instruction cache, it is determined that a corresponding address index is present, it can be seen that an instruction currently required by the PC calculator 10 is present in the instruction cache. If an instruction is present in the instruction cache through the output of the tag 16 of the instruction cache, the line 18 of the instruction cache is accessed, and an actual instruction is read. Eight instructions 20 have been grouped and stored in the line 18 of the instruction cache.

The instruction selector 22 selects some of the eight instructions 20 that are present on one line 18 of the instruction cache. That is, the instruction selector 22 checks a position where a branch instruction is present by partially decoding each of the eight instructions 20. In this case, the instruction selector 22 selects instructions from among instructions ranging from the first instruction, that is, an instruction having the smallest address, to an instruction prior to a branch instruction.

The IQ 24 stores the instructions selected by the instruction selector 22. The instructions stored in the IQ 24 are read and executed by the decoder (not illustrated) of the processor core.

The mode register 28 determines the mode (i.e., normal mode or line mode) of a dual-mode instruction fetch structure. The processor core may set the value of the mode register 28 through its own operation. For example, if the processor core processes graphics data, the processor core may determine that the mode is set to line mode because the processor core does not generate a branch instruction. In contrast, if the processor core processes data other than graphics data, the processor core may determine that the mode is set to normal mode.

If the value of the mode register 28 is a value indicative of normal mode (i.e., if normal mode has been set), the fetch multiplexer 26 fetches an instruction stored in the IQ 24. That is, if normal mode has been set, the fetch multiplexer 26 may fetch an instruction that belongs to instructions stored in the IQ 24 and that has been stored first.

If the value of the mode register 28 is a value indicative of line mode (i.e., if line mode has been set), the fetch multiplexer 26 fetches an instruction read from the line 18 of the instruction cache. That is, if line mode has been set, the fetch multiplexer 26 may fetch the first of instructions read from the line 18 of the instruction cache.

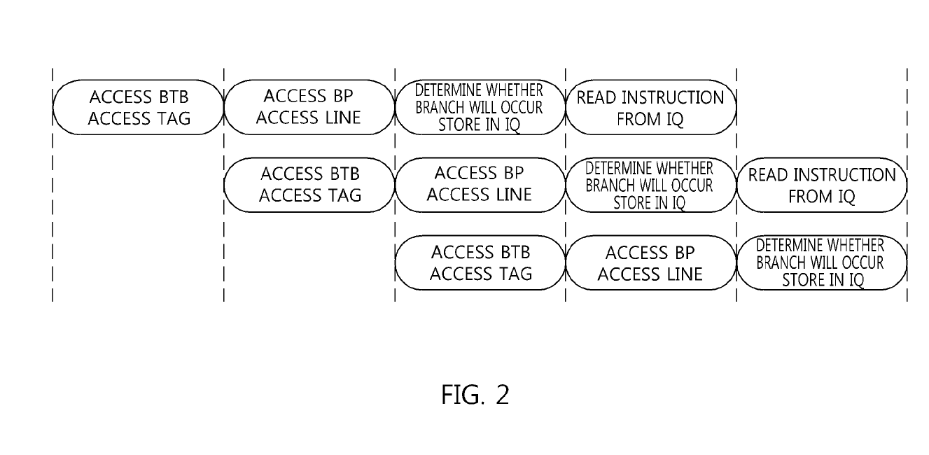

FIG. 2 is a diagram illustrating a pipeline progress structure in normal mode according to an embodiment of the present invention. In general, the number of instructions for executing an application executed by a processor core is several hundreds of times greater than the number of instructions that may be stored by a line of an instruction cache. This is a basic reason why the instruction cache is used. In this case, the instruction cache stores and executes only instructions that may be currently used, that is, some of all the instructions of the application. If the processor core operates with high performance, performance overhead attributable to a branch instruction is prevented through the branch prediction of an instruction.

If a processor core having a pipeline structure processes data other than graphics data, the value of the mode register 28 will have a value indicative of normal mode.

If the mode register 28 is set to normal mode as described above, the PC calculator 10 accesses the BTB 12 and tag 16 of the instruction cache in the first clock cycle at the same time. Thereafter, the PC calculator 10 accesses the BP 14 and line 18 of the instruction cache in the second clock cycle at the same time. In the third clock cycle, the determination of whether a branch has occurred is made based on the result of the access to the memory of the BP 14, and the result of the determination is sent to the PC calculator 10. Furthermore, the instructions selected by the instruction selector 22 are written into the IQ 24. In the fourth clock cycle, the instructions stored in the IQ 24 are read by the decoder of the processor core.

The operations of the respective clock cycles overlap each other in each clock cycle, thus forming a high-performance instruction fetch structure.

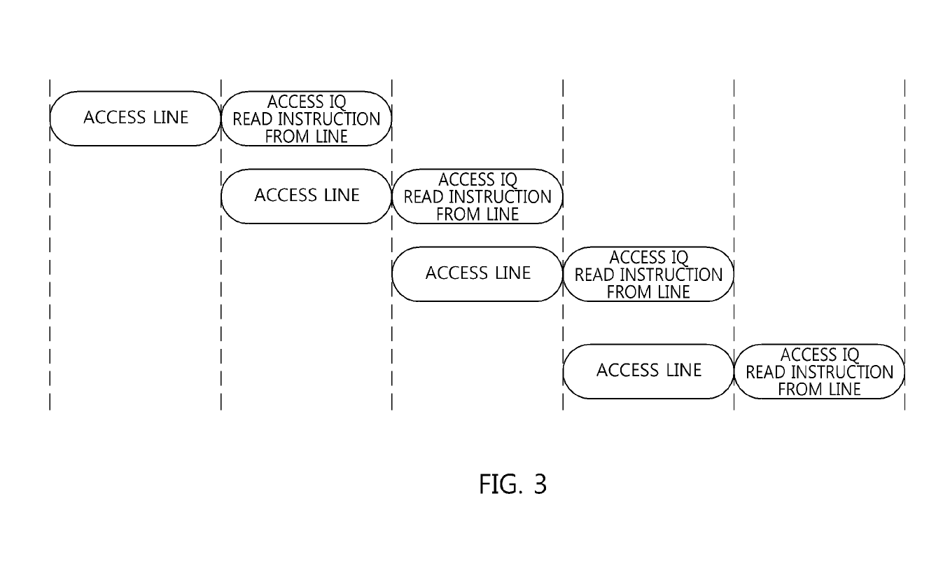

FIG. 3 is a diagram illustrating a pipeline progress structure in line mode according to an embodiment of the present invention. If a processor core processes graphics data, the processor core does not generate a branch instruction because it commonly performs a repetitive operation. As described above, if the capacity (or number) of application instructions executed by the processor core is small or if an application includes low-frequent branch instructions or both, line mode may be set. If the mode register 28 is set to line mode, an address determined by the PC calculator 10 is used to access the line 18 of the instruction cache. In this case, the tag 16 of the instruction cache is not accessed. Thereafter, the first of instructions read from the line 18 of the instruction cache is output through the fetch multiplexer 26.

That is, in the first clock cycle, the line 18 of the instruction cache is accessed based on the result of the output of the PC calculator 10. In the second clock cycle, the first of instructions output from the line 18 of the instruction cache is output through the fetch multiplexer 26.

As described above, in accordance with the present invention, in normal mode, instructions are fetched through a four-step pipeline that is composed of the PC calculator, the BTB, the BP, and the IQ, and, in line mode, instructions are fetched through a two-step pipeline that is composed of the PC calculator and the line.

Accordingly, if the number of application instructions executed by a processor core is small or an application includes low-frequent branch instructions or both, it is effective to improve overall performance because the pipeline depth can be reduced. In this case, branch prediction does not need to be performed, and performance can be improved because an application stored in the line of the instruction cache is directly read and output as a result of an instruction fetch.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A dual-mode instruction fetching apparatus, comprising:
a mode register configured to be set to one of normal mode and line mode;
a branch prediction unit;
a Program Counter (PC) calculator configured to access a tag in which address indices of instructions have been stored and a line in which the instructions have been grouped and then output an instruction, or to access only the line and then output an instruction, based on an output of the branch prediction unit, depending on a type of mode set in the mode register;
an Instruction Queue (IQ) configured to store instructions selected by an instruction selector from among the instructions grouped in the line; and
a fetch multiplexer configured to fetch the instructions stored in the IQ if the normal mode has been set, and to fetch instructions read from the line of an instruction cache if the line mode has been set.

2. The dual-mode instruction fetching apparatus of claim 1, wherein if the mode register has been set to the normal mode, the PC calculator accesses the tag and line of the instruction cache and then outputs an instruction, based on an output of the branch prediction unit.

3. The dual-mode instruction fetching apparatus of claim 1, wherein if the mode register has been set to the line mode, the PC calculator directly accesses the line of the instruction cache, other than the branch prediction unit and the tag of the instruction cache, and then outputs an instruction.

4. The dual-mode instruction fetching apparatus of claim 1, wherein if the normal mode has been set, the fetch multiplexer fetches an instruction that belongs to the instructions stored in the IQ and that has been stored first.

5. The dual-mode instruction fetching apparatus of claim 1, wherein if the line mode has been set, the fetch multiplexer fetches a first one of the instructions read from the line of the instruction cache.

6. The dual-mode instruction fetching apparatus of claim 1, wherein in the normal mode, a Branch Target Buffer (BTB) of the branch prediction unit and the tag of the instruction cache are accessed in a first clock cycle, a Branch Predictor (BP) of the branch prediction unit and the line of the instruction cache are accessed in a second clock cycle, the branch prediction unit determines whether a branch will occur and also the instructions selected by the instruction selector are stored in the IQ in a third clock cycle, and the instructions stored in the IQ are output through the fetch multiplexer in a fourth clock cycle.

7. The dual-mode instruction fetching apparatus of claim 1, wherein in the line mode, the line of the instruction cache is accessed based on an output of the PC calculator in a first clock cycle, and a first one of the instructions read from the line of the instruction cache is output through the fetch multiplexer in a second clock cycle.

8. The dual-mode instruction fetching apparatus of claim 1, wherein if a number of application instructions executed by a processor core is small or an application includes low-frequent branch instructions, the line mode is set.

9. The dual-mode instruction fetching apparatus of claim 1, wherein:
the instruction selector decodes each of the instructions grouped in the line of the instruction cache and then selects instructions from among instructions ranging from a first instruction to an instruction prior to a branch instruction; and
the IQ stores the instructions selected by the instruction selector.

10. The dual-mode instruction fetching apparatus of claim 1, wherein the apparatus is contained in a processor core having a pipeline structure.

11. A dual-mode instruction fetching method, comprising:
setting, by a processor core, one of normal mode and line mode;
fetching instructions through a PC calculator, a branch prediction unit, and an IQ in the normal mode; and
fetching instructions through the PC calculator and a line of an instruction cache in the line mode.
